(19) United States
(12) Patent Application Publication
(10) Pub. No.: US 2007/0221556 A1
(43) Pub. Date: Sep. 27, 2007

(54) Container for Reducing alkaline Water

(75) Inventor: Yong-Kyun Chung, Gyunggi-do (KR)

Correspondence Address: GREENBLUM & BERNSTEIN, P.L.C., 1950 ROLAND CLARKE PLACE, RESTON, VA, 20191, US

(73) Assignee: KOREA BIO TECHNOLOGY ENT., Seongnam-si (KR)

(21) Appl. No.: 11/570,406

(22) PCT Filed: Jun. 30, 2005
(86) PCT No.: PCT/KR05/02061

§ 371 Date: Dec. 11, 2006

(30) Foreign Application Priority Data
Sep. 11, 2004 (KR) 20-2004-0026165
Jul. 6, 2004 (KR) 20-2004-0019141

(51) Int. Cl. C02F 1/42

(52) U.S. Cl. 210/198.1

(57) ABSTRACT

The present invention provides a reducing container for creating alkaline water. The reducing container includes a drinking water cup (11), a lid (121) which is openably coupled to an opening of the cup (111), a reducing agent casing (131) which is disposed in the cup (111), and a reducing casing support means (141). The reducing container of the present invention my further include a bird song producing device The bird song producing device includes a cover plate (155) which is provided in a bottleneck, a water outlet port (156) which is formed through the cover plate (155), an air inlet port (157) which is formed through the cover plate (155), and input air flow acceleration means, so that, when the water is discharged, bird song is produced.

### TECHNICAL FIELD

The present invention relates, in general, to containers for reducing drinking water to make alkaline water. More particularly, the present invention relates to a reducing container for creating alkaline water which has a reducing mineral agent therein so that drinking water is reduced to alkaline water in the container, which is a cup type container, and which includes a bird song producing device.

### BACKGROUND ART

Generally, alkaline water, obtained by water electrolysis, and reduced alkaline water (RAW), obtained by chemical treatment using a reducing mineral agent, have been used as representative alkaline water. As the reducing mineral agent for creating alkaline water, there are magnesium, calcium granular phlogopite, granular silver, granular tourmaline, activated coconut carbon, granular clay, etc. Typically, such a granular mineral has a diameter of 5 mm and is plastic or is a particle formed in a spheroid shape.

Alkaline water having a pH of 9 or above is beneficial to health. Reduced alkaline water, which is obtained by reaction with a reducing agent purifying the properties of water, is a precursor of hexagonal water. It has been well known that reduced alkaline water protects the human body from outer commotion, thus maintaining physical stabilization. Furthermore, it has been well established that reduced alkaline water has medicinal benefits of improvement of physical defects caused by the acidification of blood and of various illnesses resulting from reactive oxygen species. In detail, alkaline water eliminates reactive oxygen species (ROS) in water, thus making the digestive system of the body healthy. During hemodialysis of a patient suffering from end-stage renal disease (ESRD), the alkaline water reduces oxidative stress. Furthermore, the alkaline water eliminates free radicals that oxidize cells of the living body, thus protecting DNA. Moreover, the alkaline water has anticancer effect, prevents diabetes, and improves atopic dermatitis. In addition, it has been reported that alkaline water is effective in improving the physical constitution, and promotes growth.

An electric alkaline water creating apparatus, which purifies raw water and creates electrolyzed water, was proposed in Korean Utility Model Registration No. 20-0330824. Furthermore, a reduced alkaline water creating apparatus using magnesium was proposed in Korean Utility Model Registration No. 20-0348739. In this apparatus, an ion cartridge is replacably installed in a main body having an inlet pipe and an outlet pipe. Raw water supplied through the inlet pipe is reduced to alkaline water by magnesium and the reduced alkaline water is discharged to the outside. Meanwhile, a water bottle was proposed in Korean Utility Model Registration No. 20-0342178. This water bottle is manufactured by assembling separate upper and lower containers using a locking bolt. A bio stone is disposed in the upper container, and water is supplied into the water bottle. Thereafter, the water bottle, turned upside down, is put on a water purifier. Then, water is discharged to the outside after passing through the bio stone. Furthermore, a bottle for water, in which a net tube having a bio stone therein is radially mounted at an upper position in the bottle so that minerals are supplied from the bio stone of the net tube, was proposed in Korean Utility Model Registration No. 20-0333989. A water bottle, in which separated lower bodies of the bottle are assembled by locking bolts, and a net container having a bio stone therein is disposed in the lower body so that the bio stone activates water supplied in the bottle, was proposed in Korean Utility Model Registration No. 20-0332588. A purified water creating bottle was proposed in Korean Utility Model Registration No. 20-026668. In this bottle, a support cap is provided on an inner surface of an opening of the bottle, and a pipe, in which a plurality of holes is formed, is coupled to the lower end of the support cap. Furthermore, filtration agents, such as fine clay powder, bio stone powder, or charcoal powder, surrounded by a filter cloth, are inserted into the pipe. A drinking water container was proposed in Korean Laid-open Publication No. 10-2004-0015695. This drinking water container includes an openable cap, which is coupled to an upper end of the container body having a predetermined volume for containing therein water, juice or functional water, and a bottom cap which is coupled to a lower end of the container body. Furthermore, a water purifying agent is provided in the bottom cap. The drinking water container further includes a first cap, a second cap and a filter. However, each of the above-mentioned conventional apparatuses is any one of an alkaline water creating apparatus that uses electricity, an alkaline water creating apparatus provided in a drinking water pipeline, a bio stone mineral drinking water apparatus applied to a spring water bottle, a drinking water containing apparatus which has a bio stone therein and is manufactured by assembling separated lower parts of a bottle using locking bolts, and a drinking water containing apparatus in which a pipe is installed in a bottle. Such containers or apparatuses for drinking water cannot be used as a portable water container or cup.

Meanwhile, bird song, such as heard in the woods, helps people relax and feel at peace. Bird song also reminds people of urban natural areas as well as forests. Due to the growth of cities and the reduction in size of natural areas, bird song has become a less important part of the lives of most people. Also, as a consequence of industrialization, air and water have become polluted. Furthermore, people consume too many processed foods, thereby acidifying their constitutions. The expansion of industrialized areas is physically and emotionally harmful to people, and thereby represents a backward step of civilization. This living environment has changed people's lifestyles and values. People have shifted from drinking subterranean water to drinking commercialized water. To prevent acidification of their constitutions, people are alkalizing their drinking water before consuming it.

To meet such needs, a reducing container for creating alkaline water was proposed in Korean Utility Model Application No. 20-2004-0019141, from which the present invention takes priority. This reducing container for creating alkaline water includes a drinking water cup, a watertight cap which is openably coupled to an opening of the cup, and a reducing agent casing which is supported in a lower end of the cup. When the cup is filled with magnesium reducing agent and water, the following reaction occurs “Mg+2H₂O→Mg(1OH)₂+H₂(=2H+2e⁻)↑→Mg⁺²+2HO⁻+H2↑”. As a result, hydrogen bubbles are created in the reducing container, and the water in the container is reduced to alkaline water being conducive to forming hexagonal water. Such alkaline water is beneficial to health. Moreover, a bird song producing device is applied to the reducing container for creating alkaline water, so that a user can feel a sense of nature and further enjoy using the reducing container.

### DISCLOSURE OF INVENTION

### Technical Problem

An object of the present invention is to provide a reducing container for creating alkaline water which is portable and contains drinking water therein like a bottle. Another object of the present invention is to provide a reducing container for creating alkaline water which allows a user to drink the contained water as from a water bottle. A further object of the present invention is to provide a reducing container which is able to reduce drinking water to alkaline water while the drinking water is contained in the reducing container. Yet another object of the present invention is to provide a reducing container for creating alkaline water which has a simple structure, thus being easy to clean. Still another object of the present invention is to provide a bird song producing device which is provided in a water bottle so that, when a user pours water or drinks water, a bird song is produced by the water bottle. Still another object of the present invention is to provide a bird song producing device for a water bottle in which, when water in the water bottle is exchanged for outside air, a bird song is produced without using a driving electric current or an electric sound producing device. Still another object of the present invention is to provide a bird song producing device which repeatedly produces both an input air vibration sound and a bubble bursting vibration sound, thus producing sound such as a bird song. Still another object of the present invention is to provide a bird song producing device for water bottles which has a simple structure, thus being easy to clean. The term “bottle container” in the present invention means a water bottle including a disposable water bottle, a reusable water bottle, a portable water bottle and a cup type water bottle.

### Advantageous Effects

The present invention provides a reducing container for creating alkaline water which is portable and can contain drinking water therein like a bottle. The present invention provides a reducing container for creating alkaline water which allows a user to drink the contained water in as from a water bottle. The present invention provides a reducing container which is able to reduce drinking water to alkaline water while the drinking water is contained in the reducing container. The present invention provides a reducing container for creating alkaline water which has a simple structure, thus being easy to clean. The present invention comprises a bird song producing device which is provided in a water bottle so that, when a user pours water or drinks water, bird song is produced from the water bottle. The present invention comprises a bird song producing device for a water bottle in which, when water in the water bottle is exchanged with outside air, a bird song is produced without using a driving electric current or an electric sound producing device. The present invention provides a bird song producing device which repeatedly produces both an input air vibration sound and a bubble bursting vibration sound, thus producing sound such as a bird song. The present invention provides a bird song producing device for water bottles which has a simple structure, thus being easy to clean.

### BRIEF DESCRIPTION OF THE DRAWINGS

FIG. 1 is an exploded perspective view of a container, according to the present invention;

FIG. 2 is a sectional view showing the container of FIG. 1;

FIG. 3 is an exploded perspective view of a reducing agent casing according to the present invention;

FIG. 4 is a sectional view showing a portion of the container body in which the reducing agent casing is disposed;

FIG. 5 is an exploded perspective view showing a container according to another embodiment of the present invention;

FIG. 6 is a sectional view showing the container of FIG. 5;

FIG. 7 is a sectional view showing an enlargement of a lid coupled to the container body of FIG. 6;

FIG. 8 is a sectional view showing a reducing agent casing assembled with the container body of FIG. 6;

FIG. 9 is an exploded perspective view showing a container including a bird song producing device, according to the present invention;

FIG. 10 is a sectional view showing the assembled container of FIG. 9;

FIG. 11 is a detailed view showing the bird song producing device of the container of FIG. 9; and

FIG. 12 is a view showing the bird song production of the container of FIG. 9.

### BEST MODE FOR CARRYING OUT THE INVENTION

Hereinafter, embodiments of the present invention will be described in detail with reference to the attached drawings.

The present invention relates to an alkaline water creating container to contain drinking water and an alkaline reducing agent therein.

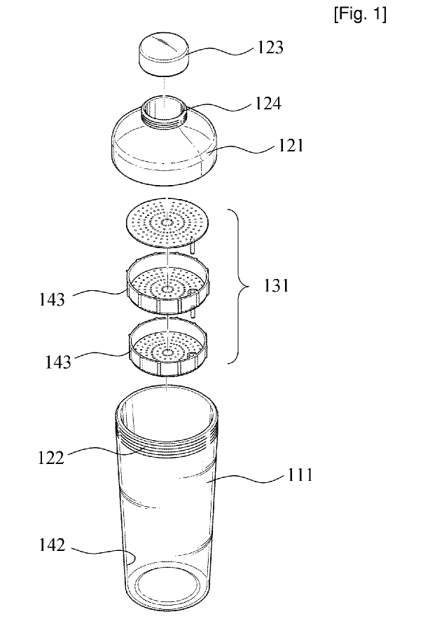

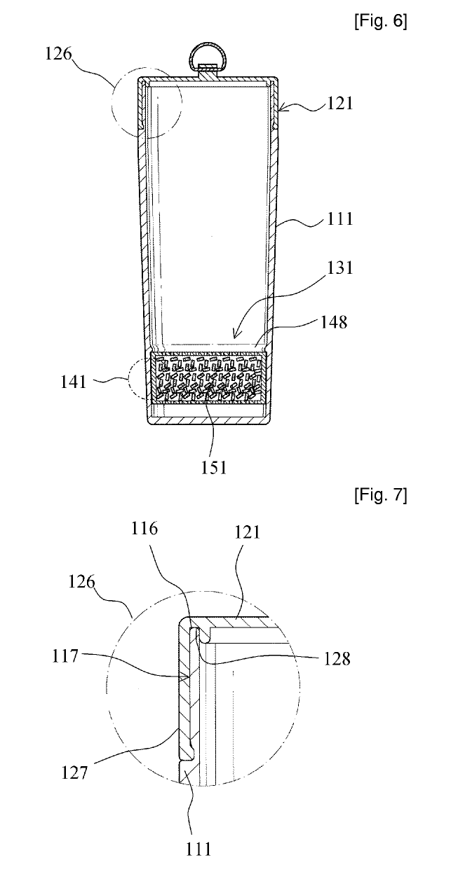

As shown in FIGS. 1 through 8, the reducing container for creating alkaline water according to the present invention includes a cup 111 having a shape that increases from a bottom to a top, and a watertight lid 121 which is openably coupled to an opening of the cup 111. The container further includes a reducing agent casing 131 which is inserted into the cup 111 through the opening, is supported in a lower end of the cup 111, and contains an alkaline reducing agent 151 therein. The reducing agent casing 131 allows the alkaline reducing agent 151 to contact the drinking water. The container further includes a reducing agent casing support means 141 which is provided on the inner surface of the lower end of the cup 111 and a circumferential outer surface of the reducing agent casing 131.

The reducing agent casing 131 is filled with at least one alkaline reducing mineral agent 151 including magnesium, calcium granular phlogopite, granular silver, granular tourmaline, activated coconut carbon and granular clay. The reducing agent casing 131, filled with the reducing agent 151, is disposed in the cup 111. The cup 111 is filled with water and is then covered with the lid 121. Then, the water is gradually reduced to alkaline water in the cup 111. In the case of using a magnesium reducing agent, the alkaline water creation process is expressed by the chemical formula “Mg+2H₂O→Mg²⁺+2OH⁻+H₂(=2H [symbol] +2⁻e)↑”. As shown in this formula, hydrogen bubbles are created in the reducing agent casing 131. The hydrogen bubbles rise above water. Therefore, a user can observe the movement of the bubbles with the naked eye. After a predetermined time period has passed, the water in the container is reduced to alkaline water being conducive to forming hexagonal water, thus providing healthy water to the user. To drink the reduced alkaline water, the user opens the lid 121 from the cup 111 and then drinks it. Alternatively, the user may pour the water into another container and drink it. The lid 121 is not involved in the process of reducing water from a neutral to an alkaline state, but serves merely to protect the water. The reducing agent 151 can be repeatedly used for about 1 to 6 months. However, the cup 111 easily becomes dirty when it is repeatedly used. As such, when it is required to wash the cup 111, the lid 121 is removed from the cup 111. Thereafter, the reducing agent casing 131 is removed from the cup 111, and the cup 111 is washed. Meanwhile, because the reducing container for creating alkaline water according to the present invention includes the watertight lid 121, even when the user goes on a picnic, is outside, or drives a car, the user can easily bring the reducing container containing water. For example, if the user goes on a picnic, water is reduced to alkaline water in the reducing container of the present invention while the user moves to the destination. When the user arrives at the destination, the user can drink the reduced alkaline water. As such, the reducing container of the present invention is handy to carry. Furthermore, because the container body is manufactured in a cup shape, the present invention is convenient for the user to drink water.

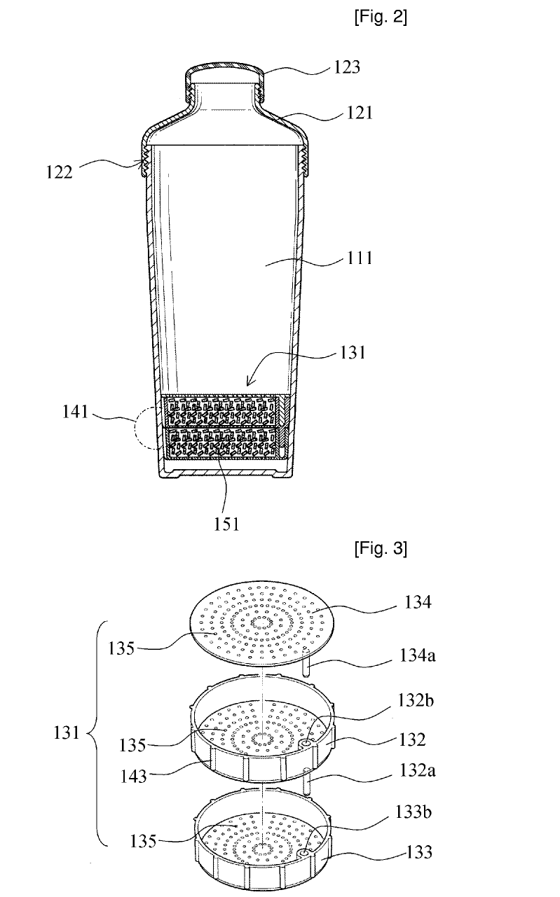

As shown in FIGS. 1 and 2, a coupling thread 122 is provided on each of the watertight lid 121 and the cup 111 to form a watertight coupling structure. The watertight coupling structure may be realized by various coupling methods as well as the above-mentioned thread coupling method. The watertight lid 121 has a bottleneck 124 which is openably closed by a cap 123. When the cup 111 is covered with the lid 121, the container assumes a bottle shape. Outdoors, the use of a cup may inconvenience the user. In the present invention, the cap 123 and the bottleneck 124 make it possible for the container to be used like a drinking water bottle. Preferably, the cap 123 comprises a screw cap.

In each embodiment shown in FIGS. 1 through 8, the reducing agent casing 131 comprises a net casing having a double layered structure. An upper casing 132 is layered on a lower casing 133. The upper casing 132 is covered with a casing top plate 134. A plurality of water flow holes 135 is formed in each of the lower casing, the upper casing and the casing top plate. A lug 134a of the casing top plate 132 is inserted into an insertion hole 132b of the upper casing 132, and a lug 132a of the upper casing 132 is inserted into an insertion hole 132b of the lower casing 133, thus completing the assembly of the reducing agent casing 131. The structure of the reducing agent casing 131 is not limited to a special structure, so long as the reducing agent casing can easily be assembled and disassembled, and can communicate with drinking water in the container.

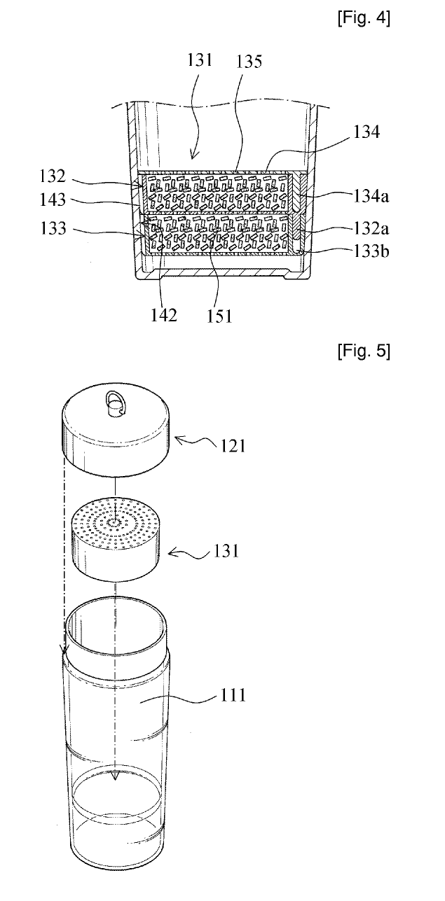

In FIGS. 1 through 8, the reducing agent casing support means 141 of the present invention includes a taper 142, which is provided on the inner surface of the cup 111, and a plurality of contact protrusions 143, which are provided on the outer surface of the reducing agent casing 131. As shown in FIG. 4, the assembled reducing agent casing 131 containing the reducing agent 151 therein is inserted into the cup 111. At this time, the contact protrusions 143 of the casing 131 apply pressure to the taper 142 of the cup 111, so that the casing 131 is supported in the cup 111. The casing 131 can be removed from the cup 111 by pulling the casing 131 upwards.

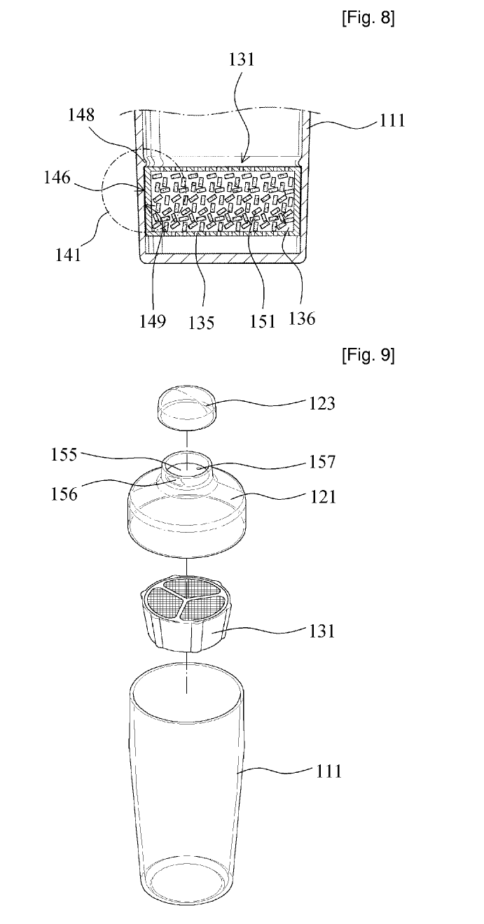

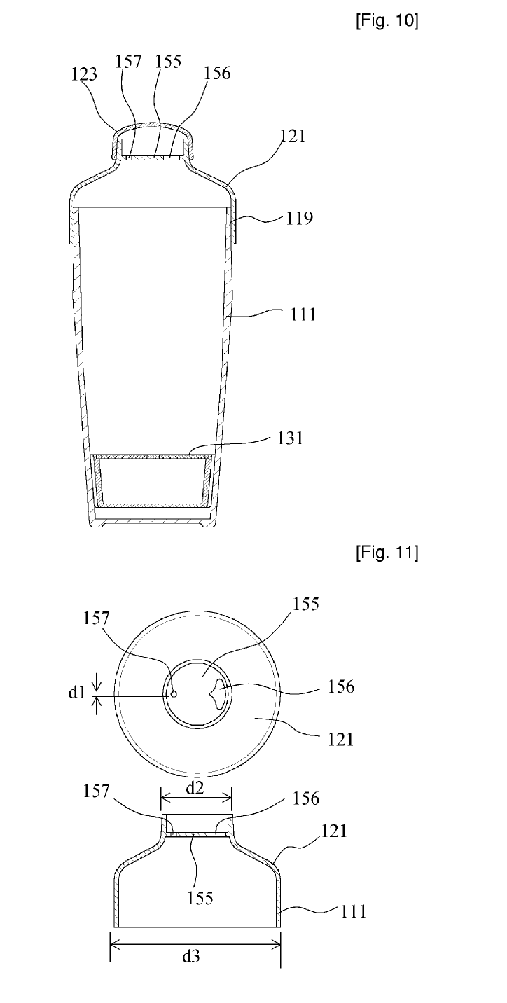

In FIGS. 5 through 7, the watertight lid 121 is coupled to the cup 111 by an elastic coupling means 126. An elastic sidewall 127 of the watertight lid 121 comes into close contact with the outer surface 117 of the cup 111. An upper edge 116 of the cup 111 comes into close contact with a ring-shaped groove 128 formed in an inner surface of the lid 121. Thus, water is prevented from leaking. This lid is used without a thread and thus has a simple structure. Unlike the container shown in FIG. 7, the outer surface 117 of the portion of the cup 111, which contacts the lid 121, may have the same thickness as that of the main body of the cup 111. As shown in FIG. 8, the reducing agent casing 131 has a simple structure. A plurality of water flow holes 135 is formed in each of the upper and lower surfaces of the reducing agent casing. The reducing agent 151 is placed in a single reducing agent seat 136 defined in the reducing agent casing. The reducing agent casing 131 of FIG. 8 may be manufactured to be separated into upper and lower parts. Alternatively, the reducing agent casing 131 may be manufactured as a single body without being separable. The support means 141 of the reducing agent casing 131 of FIG. 8 includes a taper 146, which is formed on the outer surface of the reducing casing 131, and a taper 149, which is formed on the inner surface of the cup 111. As shown in FIG. 8, the support means 141 may include a stop protrusion 148 which is provided on the inner surface of the cup 111 so as to prevent the reducing agent casing 131 from being undesirably removed. The tapers 146 and 149 and the stop protrusion 148, which prevents the casing 131 from being removed, may be selectively used. Alternatively, they may be used together. Besides, in the present invention, the support means for the reducing agent casing 131 may comprise any one among a support grip, mounted on the bottom of the container, support threads, formed on the inner surface of the container and the outer surface of the reducing agent casing, and an elastic protrusion, provided on the outer surface of the reducing agent casing and coming into close contact with the inner surface of the container.

Meanwhile, in the present invention, a bird song producing device is applied to a bottle container to contain drinking water therein. That is, the cup 111 and the lid 121 constitute the bottle container. Furthermore, the bird song producing device is mounted to a bottleneck of the bottle container. Referring to FIG. 9 and the remaining drawings, the bird song producing device includes a cover plate 155 which closes the bottleneck, a water outlet port 156 which is formed at a predetermined position in the cover plate 155 to allow a discharged water stream to free-fall through the water outlet port 156, and an air inlet port 157 which is formed at a predetermined position in the cover plate 155 so that air is drawn into the container through the air inlet port 157 by negative pressure occurring in the container when the water is discharged, thus vibrating. The bird song producing device further includes an input air flow acceleration means 154 which accelerates the input air flow to vibrate the input air at a vibration frequency corresponding to a desired bird song. The input air flow acceleration means 154, which lets the input air vibrate and produce a bird song, includes the water outlet port 156 having a size that causes the discharged water to free-fall, and the air inlet port 157 which is formed such that air is drawn into the container at a speed faster than the flow speed of the discharged water. In the input air flow acceleration means 154 for the bird song vibration, the diameter dl of the air inlet port 157 ranges from 1.5 mm to 6 mm. Furthermore, the area of the water outlet port 156 is 10 to 50 times as long as the area of the air inlet port 157. In this embodiment, the air inlet port 157 is a circular hole having an area of 4 mm². The water outlet port 156 has a shape similar to an elliptical hole and has an area of 1.4 cm². The input air flow acceleration means 154 further includes an upward air flow path 158. In this embodiment, the diameter d3 of the cup 111 is greater than the diameter d2 of the bottleneck, and the lid 121 of the cup 111 is disposed adjacent to the bottleneck such that the route of air to be drawn is defined as the upward air flow path 158. In this embodiment, the container having the cup 111 further includes a bottleneck cap 123 and a reducing agent casing 131. The lid 121 is assembled with the cup 111 by a coupling means 119. When a bird song is produced, an inside space 100 in the cup 111 serves as a resonator. The bird song production of the container of the present invention having the above-mentioned construction will be explained herein below. The cup 111 is filled with water to 70˜80% of the capacity of the cup 111, and is then covered with the lid 121. Thereafter, when the cup 111 is inclined so that the water flows outwards through the water outlet port 156, air is drawn into the container through the air inlet port 157 which is positioned at an upper position, thus producing a bird song.

### Mode for the Invention

### EXAMPLE 1

A portable transparent cup, which is made of synthetic resin and has a capacity of 600 ml, was manufactured. Furthermore, a reducing agent net casing having a capacity of 70 ml was manufactured. Here, a structure, such that the tapered outer surface of the reducing agent casing comes into close contact with the tapered inner surface of the cup, was used as a reducing agent casing supporting means. Furthermore, magnesium serving as a reducing mineral agent was inserted into the reducing agent casing. Thereafter, the reducing agent casing was supported at a lower position in the cup. Subsequently, 500 ml raw water (commercially sold water) was poured into the cup. As a result, air bubbles were observed. After 30 minutes had passed, the alkalinity of the water taken from the cup was measured. The examination revealed that the pH of the water was 11, and that its ORP was decreased to −100 mv or less.

### EXAMPLE 2

A portable transparent cup, made of synthetic resin and having a capacity of 600 ml, was manufactured. Furthermore, a reducing agent net casing having a capacity of 70 ml was manufactured. Here, a structure, such that the tapered outer surface of the reducing agent casing comes into close contact with the tapered inner surface of the cup, was used as a reducing agent casing supporting means. Furthermore, magnesium, calcium granular phlogopite, granular silver, granular tourmaline, activated coconut carbon and granular clay combined together were inserted into the reducing agent casing to serve as a reducing mineral agent. Thereafter, the reducing agent casing was supported at a lower position in the cup. Subsequently, 500 ml of raw water (commercially sold water) was poured into the cup. As a result, air bubbles were observed. After 30 minutes had passed, the alkalinity of the water in the cup was measured. The examination revealed that the pH of the water was 10, and that its ORP was decreased to −100 mv or less.

### EXAMPLE 3

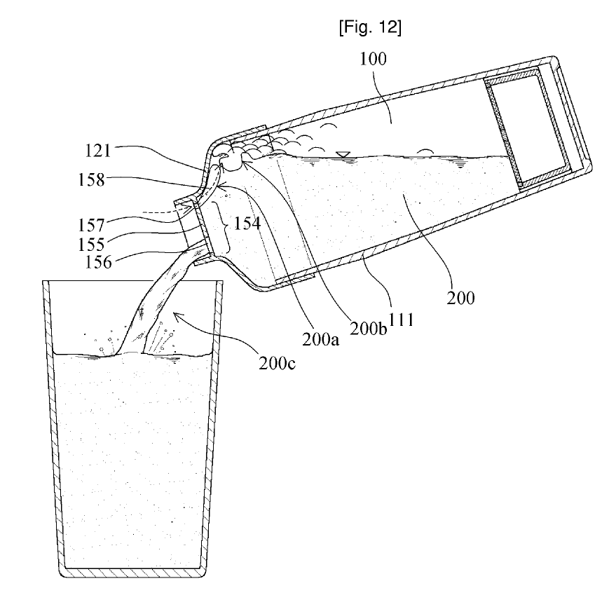

A bird song producing example: a bottle container, which includes a transparent cup having a capacity of 700 ml and a lid having the shape shown in the drawings, was manufactured. Here, the diameter of the lid of the container was 750 mm. Thereafter, a bottleneck, a cover plate, a water outlet port and an air inlet port were provided in the lid. Here, the diameter of the cover plate is 22 mm. The diameter of the air inlet port is 2 mm. The area of the water outlet port is 1.4 cm². Subsequently, 500 ml of water was poured into the cup. Thereafter, the container was inclined at about 15° such that the water was discharged to the outside through the water outlet port. As a result, the water was discharged while forming a water stream. Simultaneously, a bird song (a clean sound similar to a skylark song) was produced. The bird song was produced for approximately 20 seconds, while all of the water was discharged. Furthermore, the bird song cycled 5˜6 times per second. Such a process of producing a bird song is shown in FIG. 12. As shown in FIG. 12, the water 200 free-fell from the cup 111 through the water outlet port 156 while forming the water stream 200c. Air was drawn into the cup 111 through the air inlet port 157 by the negative pressure occurring in the container when the water was discharged from the cup 111 to the outside. The drawn air moved along the upward air flow path 158 and formed an air bubble 200a. The formed air bubble 200a grew larger and then became separated from the air inlet port 156 by increased buoyancy. Thus, the air bubble 200a moved above the surface of the water. The air bubble 200b, having reached the surface of the water, was burst by being brought into contact with the inner space 100 in the container. As such, the air bubble creation process and the bursting process repeatedly occurred 5˜6 times per second. Thereby, a disyllabic clean bird song was repeatedly produced by the combination of the input air vibration sound in the process of creating the air bubbles 200a and the bubble bursting vibration sound in the process of bursting the air bubbles 200b. From the test, the volume of the air bubbles, which produced the bird song, ranged from approximately 3 to approximately 4 cm . The produced bird song can be heard even at a distance of 30 m.

### INDUSTRIAL APPLICABILITY

As described above, the present invention provides a container for reducing drinking water to make alkaline water. The container of the present invention can create alkaline water using a mineral reducing agent without electricity. Furthermore, the present invention can be manufactured and used at an inexpensive price. As well, because a bird song is produced when water flows from the container to the outside, a user can drink water in a pleasant mood.

1. A reducing container for creating alkaline water into which drinking water and an alkaline reducing agent are supplied, wherein the reducing container comprises: a container body; a lid openably coupled to an opening of the container body; a reducing agent casing disposed and supported in the container body and containing the alkaline reducing agent therein such that the alkaline reducing agent contacts the drinking water; and support means to support the reducing agent casing in the container body.

2. The reducing container according to claim 1, wherein the support means, which supports the reducing agent casing, comprises a tapered inner surface of the container body.

3. The reducing container according to claim 1, wherein the lid is coupled to the container body, thus forming a watertight structure.

4. The reducing container according to claim 1, wherein the container body to contain the drinking water therein comprises a bottle having a bottleneck, and the container further comprises: a cover plate provided in the bottleneck; a water outlet port formed at a predetermined position through the cover plate to allow a discharged water stream to free-fall through the water outlet port; an air inlet port formed at a predetermined position through the cover plate so that air is drawn into the container through the air inlet port by negative pressure occurring in the container when the water is discharged, thus vibrating; and input air flow acceleration means, so that, when the water is discharged, a bird song is produced.

5. The reducing container according to claim 4, wherein the input air flow acceleration means comprises: the water outlet port having a size that allows the discharged water stream to free-fall; and the air inlet port formed such that air is drawn into the container body at a speed faster than a flow speed of the discharged water.

6. The reducing container according to claim 5, wherein the input air flow acceleration means comprises an upward air flow path.
